(19) United States
(12) Patent Application Publication
(10) Pub. No.: US 2003/0160159 A1
(43) Pub. Date: Aug. 28, 2003

(54) Hand-hold rotation gravity driving optical encoder

(76) Inventor: Kuo-Chen Chung, Hua-Lien Hsien (TW)

Correspondence Address: SUPREME PATENT SERVICES, POST OFFICE BOX 2339, SARATOGA, CA, 95070, US

(21) Appl. No.: 10/083,268

(22) Filed: Feb. 23, 2002

(51) Int. Cl. G01D 5/34

(52) U.S. Cl. 250/231.13

(57) ABSTRACT

A hand-hold rotation gravity driving optical encoder includes an optical encoder disk rotatably mounted in an encoder support rack which is fixed on a handle. The optical encoder disk has a non-symmetric gravity, and has an outer periphery provided with a counterweight that is not symmetric relative to a rotation center thereof. A fixing shaft is extended through the optical encoder disk and the encoder support rack, thereby mounting the optical encoder disk on the encoder support rack. The encoder support rack is provided with at least one infrared emitting and receiving photoelectric unit. The handle has a central line that may be in parallel with, vertical to or inclined with a normal line of the optical encoder disk.

### FIELD OF THE INVENTION

The present invention relates to a hand-hold rotation gravity driving optical encoder, and more particularly to a hand-hold rotation gravity driving optical encoder, wherein the user may hold and rotate the handle, so as to control the direction of movement and the position of the cursor of the computer monitor.

### BACKGROUND OF THE INVENTION

A conventional mouse or digital board may be used to control movement of the cursor of the computer monitor. However, the conventional mouse or digital board is not available for the site at a suspended state and is limited to the space, thereby greatly limiting the versatility of the cursor of the computer monitor.

### SUMMARY OF THE INVENTION

The primary objective of the present invention is to provide a hand-hold rotation gravity driving optical encoder, wherein the user may hold and rotate the handle, so as to control the direction of movement and the position of the cursor of the computer monitor.

In accordance with the present invention, there is provided a hand-hold rotation gravity driving optical encoder, comprising: an optical encoder disk rotatably mounted in an encoder support rack which is fixed on a handle, the optical encoder disk has a non-symmetric gravity, and has an outer periphery provided with a counterweight that is not symmetric relative to a rotation center thereof, a fixing shaft extended through the optical encoder disk and the encoder support rack, thereby mounting the optical encoder disk on the encoder support rack, the encoder support rack provided with at least one infrared emitting and receiving photoelectric unit. The handle has a central line that may be in parallel with, vertical to or inclined with a normal line of the optical encoder disk. Thus, the user may hold and rotate the handle, so as to control the direction of movement and the position of the cursor of the computer monitor.

Thus, the user may efficiently control the cursor of the computer monitor at a suspended state.

In addition, the user may efficiently control the cursor of the computer monitor without being limited by the space and the site.

Further, the parts of the present invention may be exchanged, thereby decreasing cost of fabrication.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand-hold rotation gravity driving optical encoder in accordance with a first embodiment of the present invention;

FIG. 2A is a front plan view of an optical encoder disk of the hand-hold rotation gravity driving optical encoder as shown in FIG. 1;

FIG. 2B is a side plan cross-sectional view of an optical encoder disk of the hand-hold rotation gravity driving optical encoder as shown in FIG. 1;

FIG. 3A is a schematic assembly operational view of the hand-hold rotation gravity driving optical encoder as shown in FIG. 1 in use;

FIG. 3B is a schematic assembly operational view of the hand-hold rotation gravity driving optical encoder as shown in FIG. 1 in use;

FIG. 3C is a schematic assembly operational view of the hand-hold rotation gravity driving optical encoder as shown in FIG. 1 in use;

FIG. 4 is an exploded perspective view of a hand-hold rotation gravity driving optical encoder in accordance with a second embodiment of the present invention;

FIG. 5A is a schematic assembly operational view of the hand-hold rotation gravity driving optical encoder as shown in FIG. 4 in use;

FIG. 5B is a schematic assembly operational view of the hand-hold rotation gravity driving optical encoder as shown in FIG. 4 in use;

FIG. 6 is an exploded perspective view of a hand-hold rotation gravity driving optical encoder in accordance with a third embodiment of the present invention;

FIG. 7A is a schematic assembly operational view of the hand-hold rotation gravity driving optical encoder as shown in FIG. 6 in use;

FIG. 7B is a schematic assembly operational view of the hand-hold rotation gravity driving optical encoder as shown in FIG. 6 in use;

FIG. 8A is a perspective view of a hand-hold rotation gravity driving optical encoder in accordance with a fourth embodiment of the present invention;

FIG. 8B is an exploded perspective view of the hand-hold rotation gravity driving optical encoder as shown in FIG. 8A;

FIG. 9A is a perspective view of a hand-hold rotation gravity driving optical encoder in accordance with a fifth embodiment of the present invention;

FIG. 9B is an exploded perspective view of the hand-hold rotation gravity driving optical encoder as shown in FIG. 9A; and

FIG. 10 is a schematic perspective view of a hand-hold rotation gravity driving optical encoder in accordance with a preferred embodiment of the present invention.

### DETAILED DESCRIPTION OF THE INVENTION

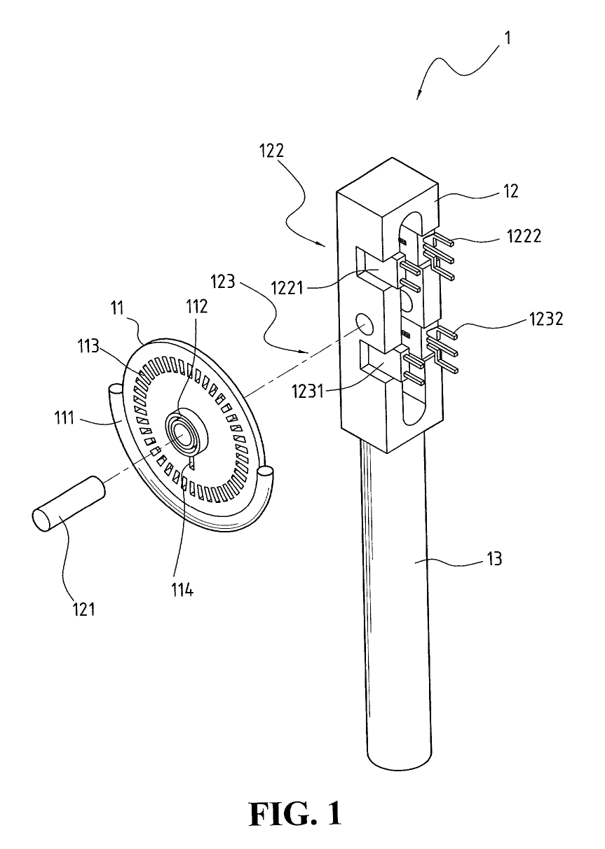

Referring to the drawings and initially to FIG. 1, a hand-hold rotation gravity driving optical encoder 1 in accordance with a first embodiment of the present invention comprises an optical encoder disk 11 rotatably mounted in an encoder support rack 12 which is fixed on a handle 13.

The optical encoder disk 11 has a non-symmetric gravity. The optical encoder disk 11 has an outer periphery provided with a counterweight 111 that is not symmetric relative to the rotation center thereof. The optical encoder disk 11 has a center provided with a bearing 112. The optical encoder disk 11 is formed with multiple encoder holes 113 and a basis hole 114 located outside of the bearing 112.

A fixing shaft 121 is extended through the bearing 112 and the encoder support rack 12, thereby mounting the optical encoder disk 11 on an encoder support rack 12. The optical encoder disk 11 having a non-symmetric gravity may be rotated on the bearing 112 and the fixing shaft 121 with little friction.

The encoder support rack 12 is provided with at least one encoder hole use infrared emitting and receiving photoelectric unit 122, and at least one basis hole use infrared emitting and receiving photoelectric unit 123. Preferably, the encoder support rack 12 is provided with two encoder hole use infrared emitting and receiving photoelectric units 122, and two basis hole use infrared emitting and receiving photoelectric units 123.

When the optical encoder disk 11 is rotated in the encoder support rack 12, the encoder hole use infrared emitting and receiving photoelectric unit 122 and the basis hole use infrared emitting and receiving photoelectric unit 123 may mate with the multiple encoder holes 113 and the basis hole 114, so that an encoder hole use infrared light emitting diode 1221 and an encoder hole use phototransistor 1222 (two bites are used) may respectively output electronic pulses whose phase difference is equal to 90 degrees, so as to detect the rotation gain and the rotation direction. In addition, a basis hole use infrared light emitting diode 1231 and a basis hole use phototransistor 1232 (only one of two bites is used) may mate with the basis hole 114 to obtain the basis angle position. The data of the encoder hole use infrared emitting and receiving photoelectric unit 122 and the basis hole use infrared emitting and receiving photoelectric unit 123 may be combined to determine the absolute position of the rotation angle.

The central line of the handle 13 is vertical to the normal line of the optical encoder disk 11. The user may hold the handle 13 with his one hand to rotate the handle 13, so as to control the direction of movement and the position of the computer cursor.

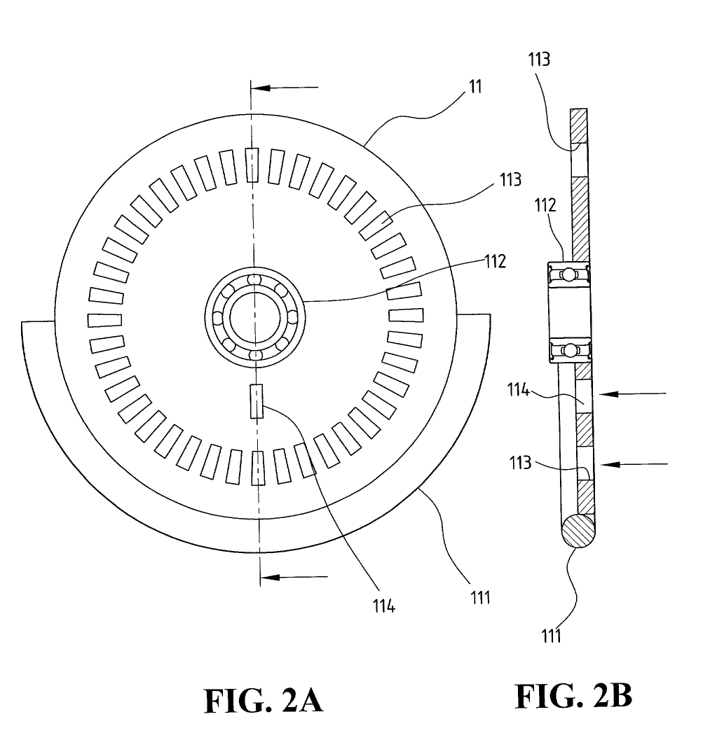

Referring to FIGS. 2A and 2B, the optical encoder disk 11 has an outer periphery provided with a semi-circular counterweight 111 that is not symmetric relative to the rotation center thereof. The optical encoder disk 11 is provided with a bearing 112, and is formed with multiple encoder holes 113 and a basis hole 114 located outside of the bearing 112. The multiple encoder holes 113 are arranged in an annular manner. By provision of the multiple encoder holes 113, the optical encoder disk 11 may form an increasing type encoder mode having opened zones and light shelter zones. The basis hole 114 may be used as the basis of the increasing angle, thereby obtaining the angle of the projecting vector of the gravity on the optical encoder disk 11 to the central axis of the handle 13.

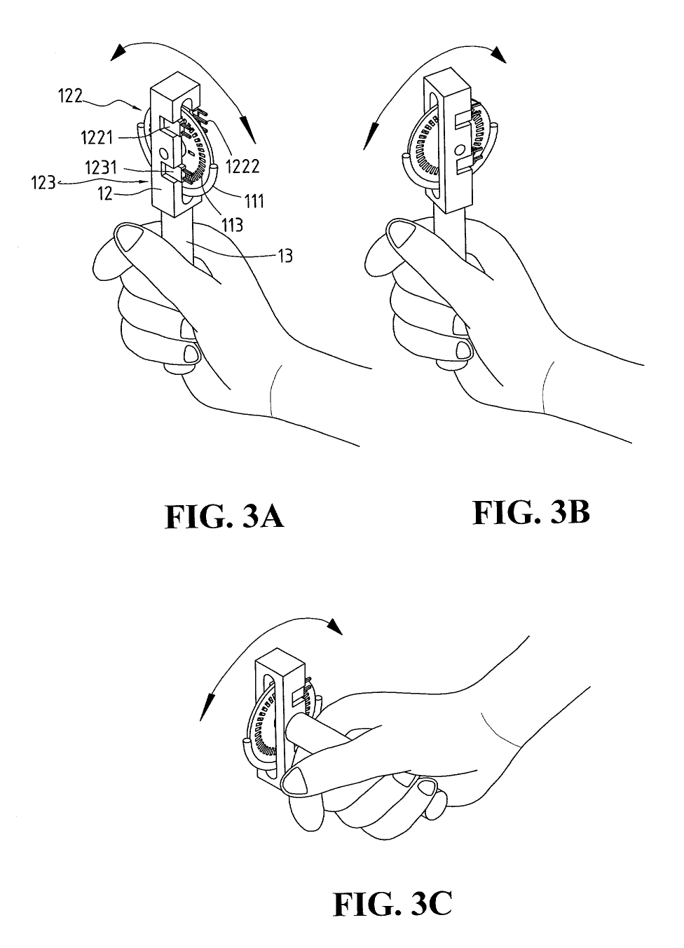

Referring to FIGS. 3A, 3B and 3C, in operation of the hand-hold rotation gravity driving optical encoder 1 in accordance with a first embodiment of the present invention, the user's palm may hold the handle and adjust the holding orientation, so that the normal line of the optical encoder disk 11 may be vertical to the user's forearm. The gravity is directly downward constantly, that is, the optical encoder disk 11 having a non-symmetric gravity is fixed along the direction of the gravity. Thus, when the encoder 1 is pivoted along the direction as indicated by arrows in FIG. 3A, the encoder support rack 12 is rotated about the center of the optical encoder disk 11. The basis hole use infrared light emitting diode 1231 and the basis hole use phototransistor 1232 may cross the basis hole 114 to obtain the basis angle position. Then, the encoder hole use infrared emitting and receiving photoelectric unit 122 and the basis hole use infrared emitting and receiving photoelectric unit 123 may be combined to inspect and determine the absolute orientation of the rotation angle. When the included angle between the normal line of the optical encoder disk 11 and the gravity is between 45 to 90 degrees, the absolute orientation may be controlled efficiently by rotating the handle 13. Thus, the encoder 1 may be pivoted along the direction as indicated by arrows in FIG. 3A, to control the movement of the vertical direction of the cursor of the computer monitor.

The encoder 1 may also be pivoted along the direction as indicated by arrows in FIG. 3B, with the normal line of the optical encoder disk 11 being in parallel with the user's forearm, so that the encoder support rack 12 is rotated about the center of the optical encoder disk 11. Thus, the encoder 1 may be pivoted along the direction as indicated by arrows in FIG. 3B, to control the movement of the horizontal direction of the cursor of the computer monitor.

The encoder 1 may also be pivoted along the direction as indicated by arrows in FIG. 3C, with the central axis of the handle 13 being in parallel with the normal line of the optical encoder disk 11, so that the encoder support rack 12 is rotated about the center of the optical encoder disk 11. Thus, the encoder 1 may be pivoted along the direction as indicated by arrows in FIG. 3C, to control the movement of the horizontal direction of the cursor of the computer monitor.

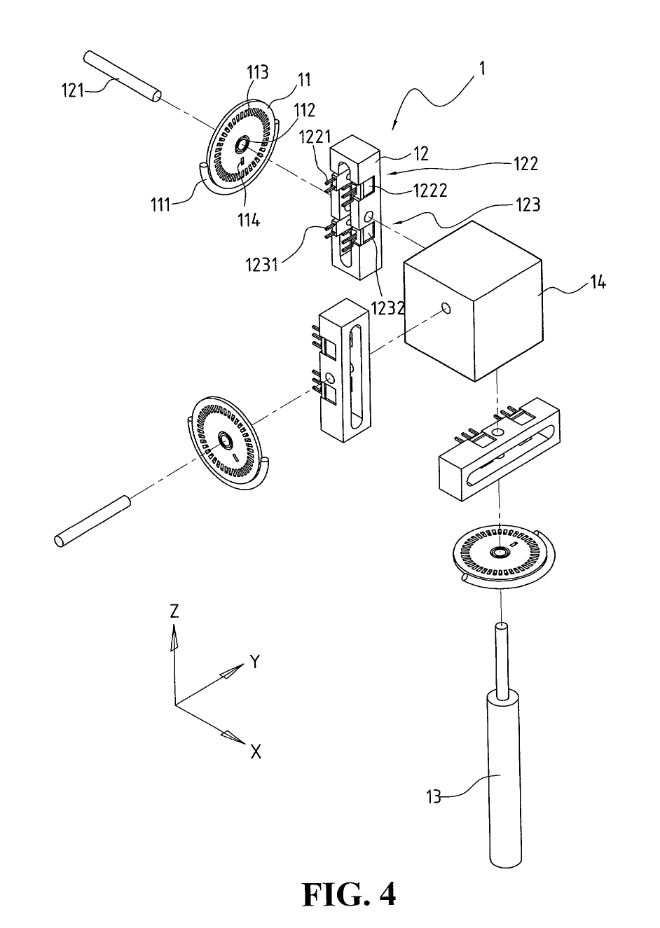

Referring to FIG. 4, a hand-hold rotation gravity driving optical encoder 1 in accordance with a second embodiment of the present invention comprises a cubic combination block 14 matingly provided with three optical encoder disks 11, three encoder support racks 12, and three fixing shafts 121 which are respectively mounted on the three mutually orthogonal planes (xy plane, yz plane and zx plane) of the cubic combination block 14.

The optical encoder disk 11 and the encoder support rack 12 mounted on the xy plane of the cubic combination block 14 is used to detect the gain of the rotation angle about the z axis, and to provide the position of the absolute angle of the gravity projecting vector on the xy plane of the cubic combination block 14, thereby calculating the position of the absolute angle of the handle 13.

The optical encoder disk 11 and the encoder support rack 12 mounted on the yz plane of the cubic combination block 14 is used to detect the gain of the rotation angle about the x axis, and to provide the position of the absolute angle of the gravity projecting vector on the yz plane of the cubic combination block 14, thereby calculating the position of the absolute angle of the handle 13.

The optical encoder disk 11 and the encoder support rack 12 mounted on the zx plane of the cubic combination block 14 is used to detect the gain of the rotation angle about the y axis, and to provide the position of the absolute angle of the gravity projecting vector on the zx plane of the cubic combination block 14, thereby calculating the position of the absolute angle of the handle 13.

The central line of the handle 13 is vertical to the xy plane. The handle 13 may be rotated arbitrarily, whereby the optical encoder disk 11 and the encoder support rack 12 mounted on the xy plane of the cubic combination block 14, the optical encoder disk 11 and the encoder support rack 12 mounted on the yz plane of the cubic combination block 14, and the optical encoder disk 11 and the encoder support rack 12 mounted on the zx plane of the cubic combination block 14 may detect the angle and the angle gain of the gravity projecting vectors relative to the basis positions of the xy plane, the yz plane and the zx plane of the cubic combination block 14. Then, the data may be recorded in the memory and processed by the micro controller, thereby obtaining the included angles between the normal lines of the xy plane, the yz plane and the zx plane of the cubic combination block 14 and the gravity direction, and thereby calculating the absolute orientation of the handle 13 in the space.

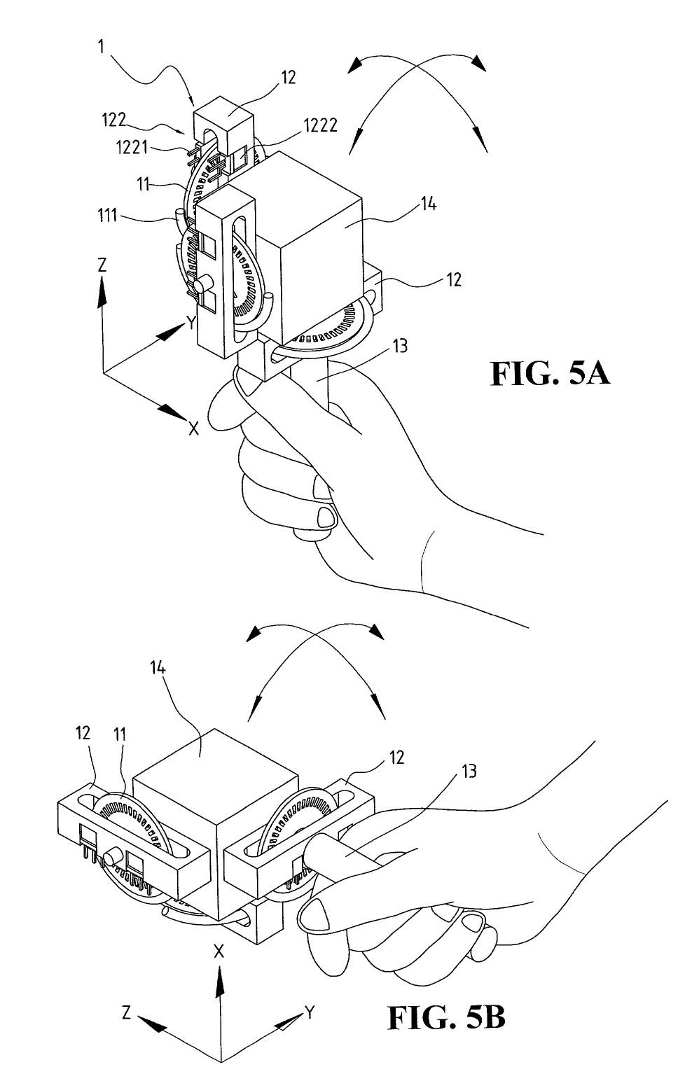

Referring to FIGS. 5A and 5B, the encoder 1 may be pivoted about y axis, so as to control the movement of the vertical direction of the cursor of the computer monitor. The encoder 1 may also be pivoted about x axis, so as to control the movement of the horizontal direction of the cursor of the computer monitor. The encoder 1 may also be pivoted about z axis, so as to control the movement of the horizontal direction of the cursor of the computer monitor.

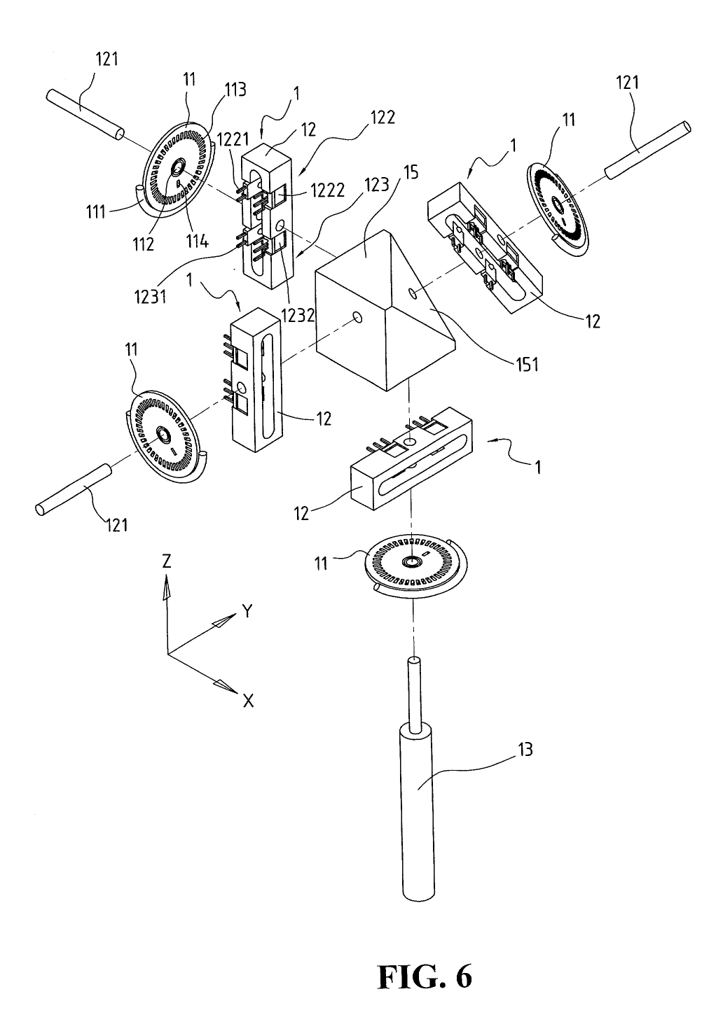

Referring to FIG. 6, a hand-hold rotation gravity driving optical encoder 1 in accordance with a third embodiment of the present invention comprises a non-cubic combination block 15 matingly provided with more than three optical encoder disks 11, more than three encoder support racks 12, and more than three fixing shafts 121 which are respectively mounted on more than three non-orthogonal planes of the non-cubic combination block 15 which includes at least one inclined face 151.

The optical encoder disk 11 and the encoder support rack 12 mounted on each plane of the combination block 15 is used to detect the gain of the rotation angle about the normal line of each plane of the combination block 15, and to provide the position of the absolute angle of the gravity projecting vector on each plane of the combination block 15, thereby calculating the position of the absolute angle of the handle 13 in the space. The central line of the handle 13 is vertical to the joint plane. The handle 13 may be rotated arbitrarily.

The joint plane of the handle 13 with the optical encoder disk 11 and the encoder support rack 12 is defined as xy plane. Then, two planes that may be easily processed are defined as yz plane and zx plane.

When the handle 13 may be rotated arbitrarily, the optical encoder disk 11 and the encoder support rack 12 mounted on each plane may be used to detect the gain of the rotation angle about the normal line of each plane, and to provide the position of the absolute angle of the gravity projecting vector on each plane. Then, the data may be recorded in the memory and processed by the micro controller, thereby obtaining the included angles between the normal lines of the xy plane, the yz plane and the zx plane of the cubic combination block 14 and the gravity direction, and thereby calculating the absolute orientation of the handle 13 in the space.

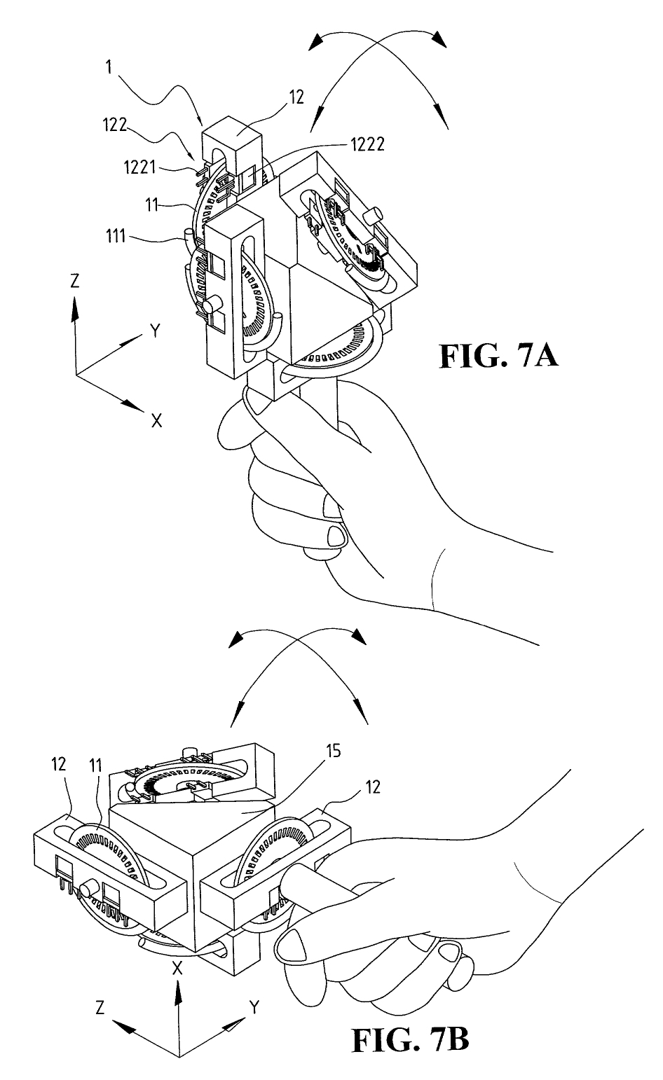

Referring to FIGS. 7A and 7B, the encoder 1 may be pivoted about y axis, so as to control the movement of the vertical direction of the cursor of the computer monitor. The encoder 1 may also be pivoted about z axis, so as to control the movement of the horizontal direction of the cursor of the computer monitor. The encoder 1 may also be pivoted about x axis, so as to control the movement of the horizontal direction of the cursor of the computer monitor.

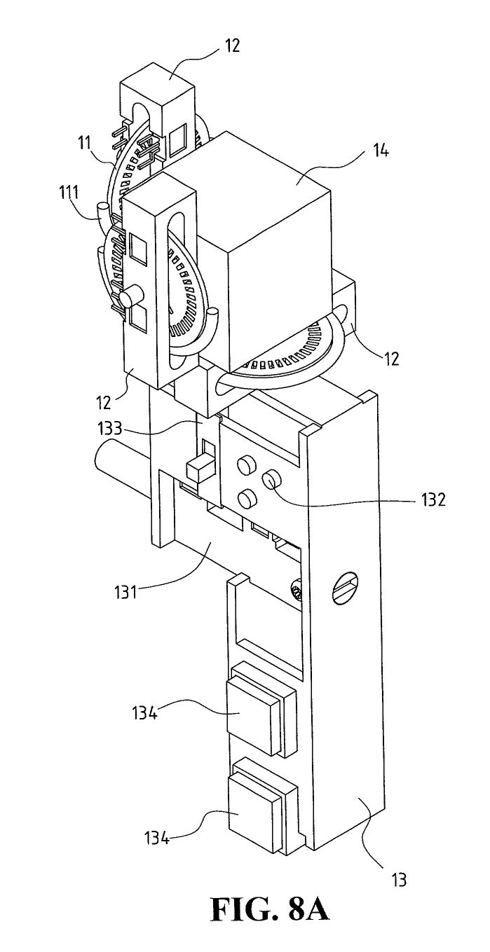

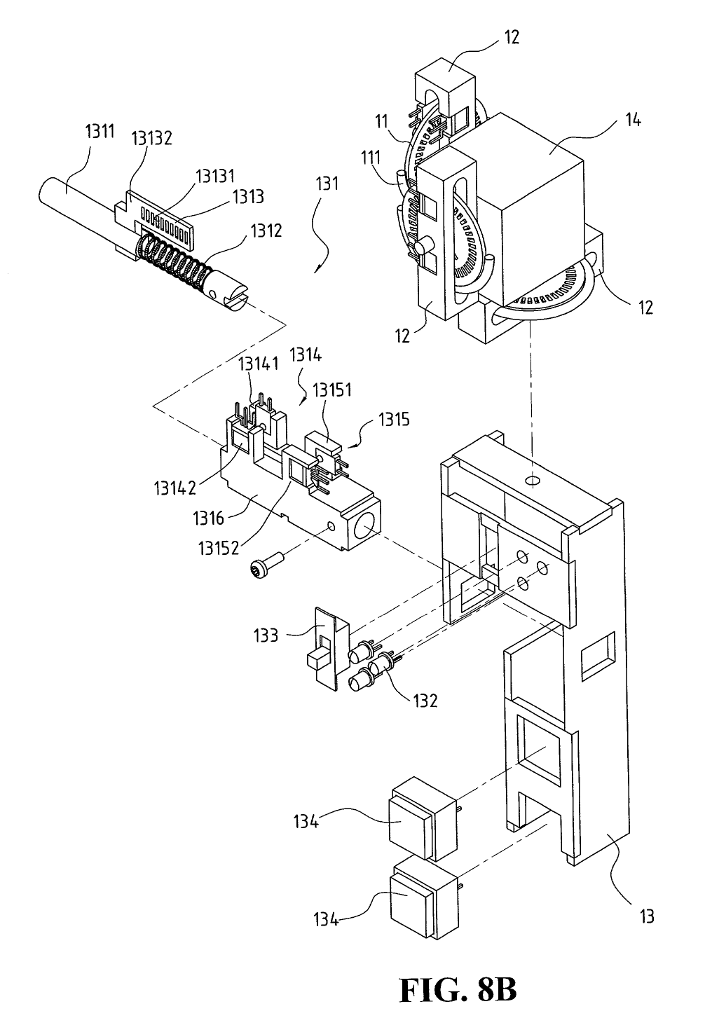

Referring to FIGS. 8A and 8B, a hand-hold rotation gravity driving optical encoder 1 in accordance with a fourth embodiment of the present invention comprises a cubic combination block 14 matingly provided with three optical encoder disks 11, three encoder support racks 12, and three fixing shafts 121.

The handle 13 may be additionally provided with a spring optical type velocity controller 131, a reset indication LED 132, an operation mode switch 133, and control buttons 134.

The spring optical type velocity controller 131 includes a drive rod 1311, a spring 1312, an optical encoding plate 1313, a reset use infrared emitting and receiving photoelectric unit 1314, an increasing type encoding use infrared emitting and receiving photoelectric unit 1315, and a support seat 1316.

When the drive rod 1311 transmits a pressure in a piston manner to the spring 1312, the optical encoding plate 1313 may be moved. The compression distance of the spring 1312 is proportional to the velocity of movement of the cursor. The optical encoding plate 1313 is formed with multiple linearly increasing type encoding plate encoding holes 13131, thereby forming opened zones and light shelter zones. The optical encoding plate 1313 has one end provided with a reset use light shelter zone 13132 for resetting the encoding values.

Before the drive rod 1311 is pressed, the reset use light shelter zone 13132 may shelter the light from the reset use light emitting diode 13141 to the reset use phototransistor 13142, so that the encoding values are reset. After the drive rod 1311 is pressed, the light is passed through the reset use light emitting diode 13141 and the reset use phototransistor 13142. At this time, the encoding values are determined by passing or sheltering the light through a linearly increasing use light emitting diode 13151 and an increasing use phototransistor 13152. The spring optical type velocity controller 131 may be controlled by the user's finger. Before the user's finger exerts a pressure, the cursor on the monitor is still. The compression distance of the spring 1312 is proportional to the velocity of movement of the cursor. If the angle gain of the rotation variation of the handle 13 is fixed, the greater of the compression distance of the spring 1312, the greater of the velocity of movement of the cursor.

The reset indication LED 132 is mounted on the panel of the handle 13, to mate with the original states of the basis hole 114 of the optical encoder disk 11. As shown in FIG. 1, before the basis hole 114 of the optical encoder disk 11 passes the basis hole use infrared light emitting diode 1231 and the basis hole use phototransistor 1232, the reset indication LED 132 will light. When the handle 13 is rotated, and the basis hole 114 of the optical encoder disk 11 passes the basis hole use infrared light emitting diode 1231 and the basis hole use phototransistor 1232, the reset indication LED 132 will extinguish.

The operation mode switch 133 may be mounted on the handle 13, and has two operation modes. In addition, the control buttons 134 mounted on the handle 13 may execute the functions of the control buttons of the mouse.

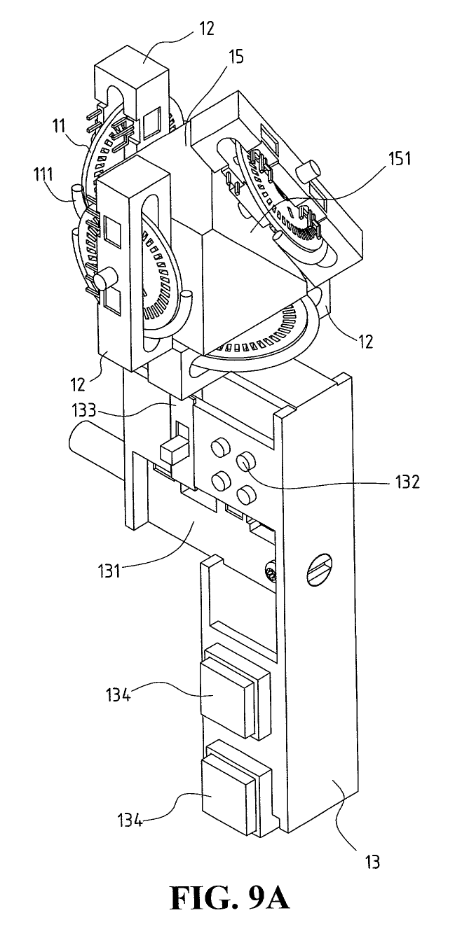

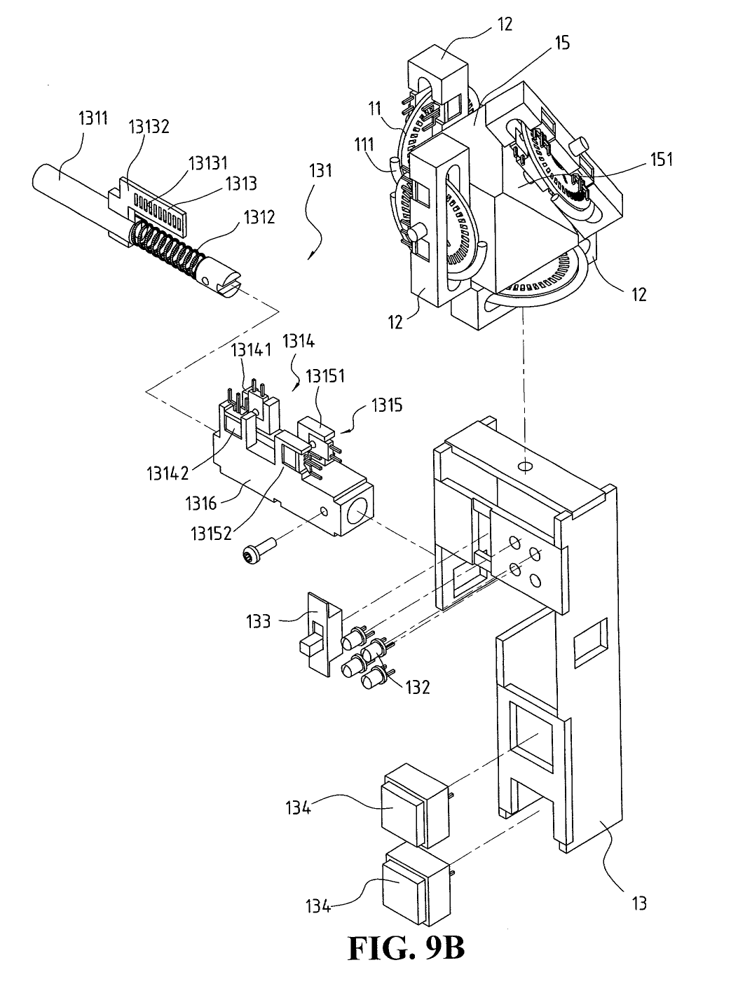

Referring to FIGS. 9A and 9B, a hand-hold rotation gravity driving optical encoder 1 in accordance with a fifth embodiment of the present invention comprises a non-cubic combination block 15 matingly provided with more than three optical encoder disks 11, more than three encoder support racks 12, and more than three fixing shafts 121. The structure of the fifth embodiment is the same as that of the fourth embodiment, and will not further be described in detail.

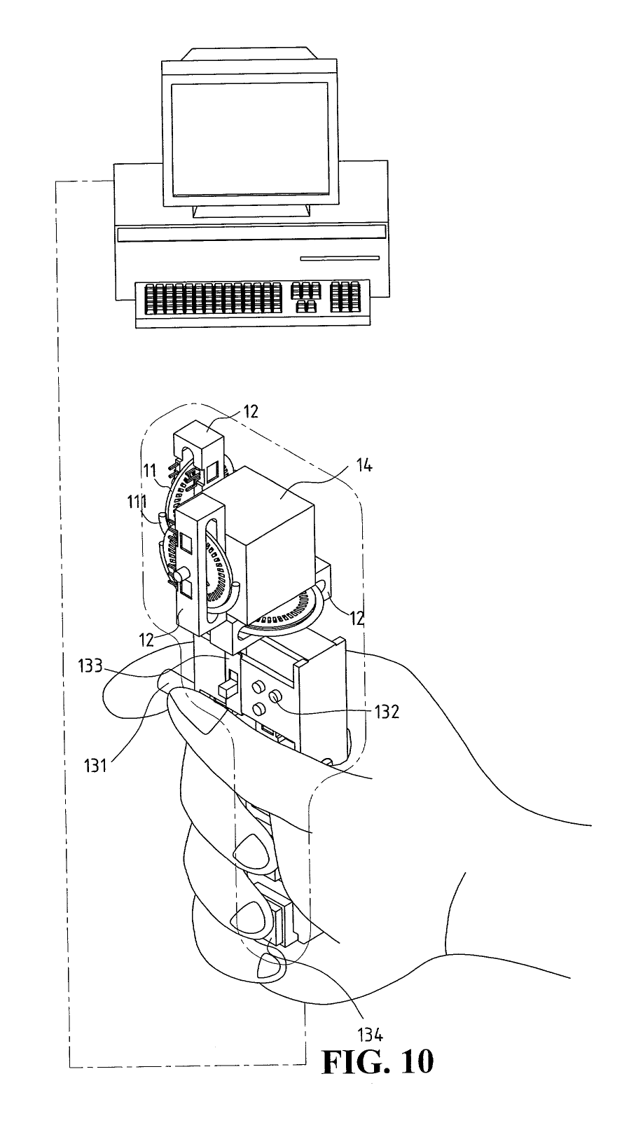

Referring to FIG. 10, the handle 13 may be additionally provided with a spring optical type velocity controller 131, a reset indication LED 132, an operation mode switch 133, and control buttons 134.

When the electric power starts, the reset indication LED 132 of the xy, yz and zx planes will light. Then, the handle 13 may be rotated to perform the reset action. At this time, the reset indication LED 132 of the xy, yz and zx planes will distinguish, which indicates that the normal operation is ready. Then, the operation mode switch 133 may be pressed to determine the operation modes. The cursor on the monitor is still before the drive rod 1311 is pressed if the handle 13 is rotated. Then, the drive rod 1311 may be pressed, and the handle 13 may be rotated, so that the cursor will move on the monitor according to the determined operation mode. The drive rod 1311 may be pressed more largely, so that the cursor may be moved faster. When the cursor reaches the determined position, the drive rod 1311 may be released, so that the cursor may be stopped. Thus, the hand-hold rotation gravity driving optical encoder 1 in accordance with the present invention may function as a mouse by co-operation of the control buttons 134.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A hand-hold rotation gravity driving optical encoder, comprising: an optical encoder disk rotatably mounted in an encoder support rack which is fixed on a handle, the optical encoder disk has a non-symmetric gravity, and has an outer periphery provided with a counterweight that is not symmetric relative to a rotation center thereof, a fixing shaft extended through the optical encoder disk and the encoder support rack, thereby mounting the optical encoder disk on the encoder support rack, the encoder support rack provided with at least one infrared emitting and receiving photoelectric unit.

2. The hand-hold rotation gravity driving optical encoder in accordance with claim 1, wherein the optical encoder disk has a center provided with a bearing.

3. The hand-hold rotation gravity driving optical encoder in accordance with claim 1, wherein the optical encoder disk is formed with multiple encoder holes, so that the optical encoder disk forms an increasing type encoder mode having opened zones and light shelter zones.

4. The hand-hold rotation gravity driving optical encoder in accordance with claim 1, wherein the optical encoder disk is formed with a basis hole serving as a basis of an increasing angle, thereby obtaining the angle of the projecting vector of the gravity on the optical encoder disk to the central axis of the handle.

5. The hand-hold rotation gravity driving optical encoder in accordance with claim 1, wherein the encoder support rack is provided with two infrared emitting and receiving photoelectric units.

6. The hand-hold rotation gravity driving optical encoder in accordance with claim 5, wherein a first infrared emitting and receiving photoelectric unit includes an infrared light emitting diode and a two-bite phototransistor, whereby the infrared light emitting diode and the two-bite phototransistor respectively output electronic pulses whose phase difference is equal to 90 degrees, so as to detect the rotation gain and the rotation direction, and a second infrared emitting and receiving photoelectric unit includes an infrared light emitting diode and an one-bite phototransistor which mates with the basis hole to obtain the basis angle position, and the data of the two infrared emitting and receiving photoelectric units are combined to determine the absolute position of the rotation angle.

7. The hand-hold rotation gravity driving optical encoder in accordance with claim 1, wherein the handle has a central line that is in parallel with, vertical to or inclined with a normal line of the optical encoder disk.

8. The hand-hold rotation gravity driving optical encoder in accordance with claim 1, wherein the hand-hold rotation gravity driving optical encoder comprises a cubic combination block matingly provided with three optical encoder disks, three encoder support racks, and three fixing shafts which are respectively mounted on three mutually orthogonal planes (xy plane, yz plane and zx plane) of the cubic combination block.

9. The hand-hold rotation gravity driving optical encoder in accordance with claim 1, wherein the hand-hold rotation gravity driving optical encoder comprises a non-cubic combination block matingly provided with more than three optical encoder disks, more than three encoder support racks, and more than three fixing shafts which are respectively mounted on mutually non-orthogonal planes of the non-cubic combination block.

10. The hand-hold rotation gravity driving optical encoder in accordance with claim 8, wherein the handle is additionally provided with a spring optical type velocity controller, a reset indication LED, an operation mode switch, and control buttons.

11. The hand-hold rotation gravity driving optical encoder in accordance with claim 10, wherein the spring optical type velocity controller includes a drive rod, a spring, an optical encoding plate, a reset use infrared emitting and receiving photoelectric unit, an increasing type encoding use infrared emitting and receiving photoelectric unit, and a support seat.

12. The hand-hold rotation gravity driving optical encoder in accordance with claim 9, wherein the handle is additionally provided with a spring optical type velocity controller, a reset indication LED, an operation mode switch, and control buttons.

13. The hand-hold rotation gravity driving optical encoder in accordance with claim 12, wherein the spring optical type velocity controller includes a drive rod, a spring, an optical encoding plate, a reset use infrared emitting and receiving photoelectric unit, an increasing type encoding use infrared emitting and receiving photoelectric unit, and a support seat.
